(19) United States
(12) Patent Application Publication
(10) Pub. No.: US 2005/0060124 A1
(43) Pub. Date: Mar. 17, 2005

(54) Method and apparatus to enhance product remote customer serviceability

(76) Inventors: Feng Chen, Wichita, KS (US); John David Cunningham JR., Wichita, KS (US); Steven G. Hagerott, Wichita, KS (US); Robin Huber, Wichita, KS (US); Miriam Edith Savage, Wichita, KS (US)

Correspondence Address: LSI Logic Corporation;Legal Department - IP, 1621 Barber Lane, MS D-106, Milpitas, CA, 95035, US

(21) Appl. No.: 10/664,571

(22) Filed: Sep. 17, 2003

(51) Int. Cl. G06F 15/00

(52) U.S. Cl. 702/185

(57) ABSTRACT

A scan tool is provided for automated remote data collection. The scan tool is provided to and executed at the customer site. The scan tool collects debug data, including, for example, configuration information, and sends the debug data to a customer service site. A comparison utility at the customer service site compares the debug data to a code level database, which holds valid code levels and their relationships. Historical and current data may be searched. Code levels may be updated and maintained in the code level database. The comparison utility presents mismatches, which may then be communicated back to the customer. If there are no mismatches, engineers may manually check the debug data for errors, which may also be communicated to the customer.

### BACKGROUND OF THE INVENTION

1. Technical Field:

The present invention relates to data processing systems and, in particular, to storage area networks. Still more particularly, the present invention provides a method, apparatus, and program to provide remote customer serviceability.

2. Description of the Related Art:

Companies dedicate a significant share of resources to provide timely and quality customer service. When customers have problems in using a company's products, debug data must be collected. Engineers may then conduct data analysis to isolate a problem. If the problem is a known error, such as an incompatible code combination, engineers may provide instruction to correct the error. Otherwise, the developer may provide a fix in a future build.

Engineers currently collect data through telephone calls, electronic mail, or other communication methods. This can result in an extended timeframe before the problem is resolved. Customers may become frustrated with the number of questions and the burden of collecting and communicating configuration information. Furthermore, communication through telephone calls and electronic mail is inefficient. This type of communication requires a manual operation both on the customer side and on the site of the customer support department. The experience on both sides may have significant impact on the effectiveness of data collection and, hence, the quality of the collected data. An inexperienced customer engineer may significantly slow down the process or provide incorrect data, which may mislead the problem resolution effort later.

Engineers may also perform on-site data collection and debugging by traveling to the customer site. On-site data collection may provide more accurate data; however, it is time-consuming and expensive. Field engineers and sometimes even developers or test engineers have to spend hours or days to travel, perhaps across the continent. All the engineers have to do is collect a list of data. Considering engineering opportunity cost is at least a few hundred dollars per hour per engineer, on-site debugging may become very expensive.

Engineers must remember the correct code levels and their combinations to correct the problem at the customer site. Customers may become frustrated when asked configuration questions while the system is degraded or down. In an attempt to correct unknown configuration issues, parts may be shipped and swapped out resulting in no change to the user. This may compound the frustration for both the customer and the customer support team.

Engineers also manually analyze the data on-site or bring the data back for further analysis. Individual engineers memorize the configuration information and the information is being changed daily. When a key engineer forgets some piece of information, errors may be overlooked during the analysis. If an engineer leaves the company, it may take a long time to rebuild this human database in a new employee. Manual data analysis may also be tedious, time-consuming, and sometimes even error-prone. For example, an engineer may easily overlook a wrong firmware version among a long list of other version numbers.

Correct configuration information may be communicated back to the customer through electronic mail. This information may include correct code levels, valid combinations, topology information, etc.

### SUMMARY OF THE INVENTION

The present invention provides a scan tool for automated remote data collection. The scan tool is provided to and executed at the customer site. The scan tool collects debug data, including, for example, configuration information, and sends the debug data to a customer service site. A comparison utility at the customer service site compares the debug data to a code level database, which holds valid code levels and their relationships. Historical and current data may be searched. Code levels may be updated and maintained in the code level database. The comparison utility presents mismatches, which may then be communicated back to the customer. If there are no mismatches, engineers may manually check the debug data for errors, which may also be communicated to the customer.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a pictorial representation of an exemplary network of data processing systems in which the present invention may be implemented;

FIG. 2 illustrates a block diagram of an exemplary problem resolution mechanism in accordance with a preferred embodiment of the present invention; and

FIG. 3 is a flowchart illustrating the operation of remote problem resolution in accordance with a preferred embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

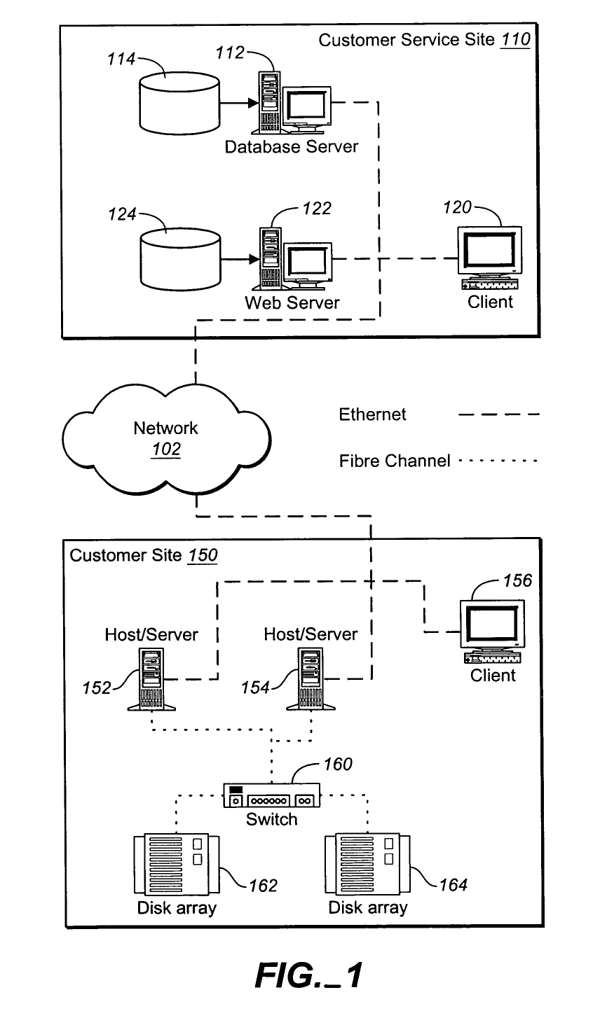

With reference now to the figures, FIG. 1 depicts a pictorial representation of an exemplary network of data processing systems in which the present invention may be implemented. The network data processing system is a network of computers in which the present invention may be implemented. The network data processing system contains a network 102, which is the medium used to provide communications links between various devices and computers connected together within the network data processing system. Network 102 may include connections, such as wire, wireless communication links, or fiber optic cables.

Customer service site 110 is connected to a customer site 150 through network 102. At the customer service site, database server 112 and Web server 122 are connected to network 102 through an Ethernet connection. Database server 112 provides access to a database 114. Web server 122 provides access to storage 124. Client 120 is connected to database server 112 and Web server 122, as well as network 102, through an Ethernet connection.

Customer site 150 includes a storage area network, which is supported by resources at the customer service site. Host/server 152, host/server 154, and client 156 are connected to network 102 through an Ethernet connection. Host/server 152 and host/server 154 are part of the storage area network and are connected to switch 160 through fibre channel connections. The switch is also connected to disk arrays 162, 164 through fibre channel.

When a problem occurs at the customer site, the customer provides debug data to the customer service site for problem resolution. The debug data may include configuration information from devices in the storage area network. For example, for a disk array, the configuration information may include the array model, firmware version, automatic volume transfer (avt) on/off, non-volatile random-access memory (NVRAM) summary, and status summary. The configuration information for a disk array may also includes statistics for each controller, for example. For a host/server, the configuration information may include, for example, the host model, the operating system version, operating system patch version, and management software versions. The configuration information for a host/server may also include statistics for each host bus adapter in the host/server, for example. For a switch or hub, the configuration information may include how each port is initialized. For example, a port may initialize as a fabric type or a fabric loop type. A switch may be a zoned switch, in which case the configuration information may include, for example, the switch model, firmware, and statistics summary. The configuration snapshot for the switch may also includes parameters for each zone. Each port of each zone may include port, zone, and port type.

In accordance with a preferred embodiment of the present invention, a scan tool is provided at the customer site for collecting the debug data. The scan tool may be provided through a manual distribution on removable media, such as a floppy disk or optical disk. In a preferred embodiment, the scan tool is downloaded from the customer service site. For example, the scan tool may be provided in storage 124 through Web server 122. Thus, when a problem is encountered at the customer site, the customer may download the scan tool from Web server 122 using client 156.

The scan tool automatically collects a pre-defined list of debug data, including configuration information, by scanning the devices in the storage area network. In the example shown in FIG. 1, the scan tool may run on client 156 and gather configuration information for host/server 152, host/server 154, switch 160, and disk arrays 162, 164. The scan tool output includes a predefined list of debug data. This list may be defined and reviewed by application engineers, firmware developers, software developers, and test engineers during development and revision of the scan tool. This list of debug data may provide maximized debug information and cover the most common setup errors occurred in customer fields.

The customer then sends the debug data to a customer support engineer at the customer service site. For example, the debug data may be transferred directly to client 120 through network 102. The debug data may be sent in other ways, such as through electronic mail or by providing the debug data in a shared storage at the customer site. The scan tool output is preferably saved in binary form by default. However, the customer site may be protected by a firewall or a security check (not shown), in which case, the firewall or the security check may not allow binary data to flow from the customer to the customer support site. In this case, the customer may contact the customer support team to obtain a special scan parameter, which may be used to save and output scan output in text format. The customer may then print the contents of the file, pass their company's security check, and send the data to the customer support team. In an alternative embodiment, the scan tool obfuscates or encodes the contents of the debug file by default to protect the customer's information. However, if this is not allowed, debug data in a plain and unsecured text form is also an available option.

At customer service site 110, a customer support engineer may run a comparison utility on the debug data. For example, the customer support engineer may run the comparison utility on client 120. Storage 114 stores a code level database, which holds valid code levels and their relationships. The comparison utility compares the debug data to the code level database and determines whether there are any mismatches. These mismatches may then be communicated back to the customer along with instructions for correcting the problem. Preferably, customer service site 110 is protected by a firewall. In such a case, the customer cannot access the comparison utility or the code level database directly.

In the depicted example, the network data processing system is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, the network data processing system also may be implemented as a number of different types of networks, such as for example, an intranet, a local area network (LAN), or a wide area network (WAN).

The architecture shown in FIG. 1 is meant to illustrate an example of a customer support environment and is not meant to imply architectural limitations. Those of ordinary skill in the art will appreciate that the configuration may vary depending on the implementation. For example, more or fewer disk arrays may be included. Also, more or fewer servers may be used. The storage area network may include a zoned switch. Web server 122 may be provided at an alternate location, such as a Web hosting site.

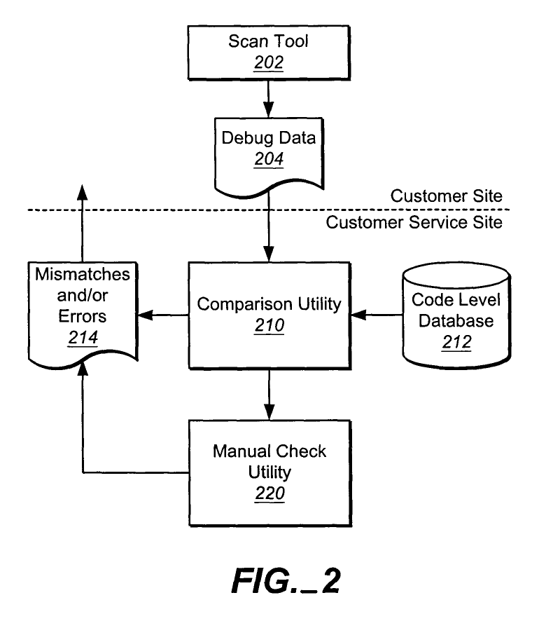

FIG. 2 illustrates a block diagram of an exemplary problem resolution mechanism in accordance with a preferred embodiment of the present invention. Scan tool 202, at the customer site, scans the customer's product, such as a storage area network, and generates debug data 204. The debug data may include, for example, settings, driver versions, and firmware versions. The debug data is sent to a customer service site. The scan tool connects to each host and switches in the configuration through Ethernet. Storage array information may be gathered either through Ethernet, if the array is network attached, or through an agent host, if the array is managed through the agent host. Then the data is saved into a file, either in binary or plain text format based on user selection.

At the customer service site, comparison utility 210 compares debug data 204 to code level database 212. The comparison utility first parses the output of the scan tool, which is either in binary form or in plain text format. The data is then compared with the code levels in the code level database. If any mismatch is found, error messages and preferred code levels are provided. The comparison utility may be either a stand-alone application or a plug-in package to be added to another application.

The code level database includes all valid code levels and combinations that have been tested and validated by the company's internal processes. The data includes code levels for controller firmware, host software, drive, switch, host bus adapter, bridge, valid combinations, and the like. Company team leaders and key engineers monitor and update the data, as needed. The comparison utility may query the code level database to get the most up-to-date code level information.

The term “code level” refers to all version information, such as controller firmware version, host bus adapter versions, host operating system version and patch version, switch/hub/bridge firmware version, etc. Usually, a host bus adapter includes several pieces of code and each may have a different version. In general, any version information that may help to debug a problem can be applied to this term.

Manual check utility 220 may be used by a customer support engineer to identify errors if the comparison utility did not identify mismatches. The manual check utility may simply be a user interface at a workstation to allow/help an engineer to manually analyze the debug data.

The manual check utility may also be used in conjunction with the comparison utility to identify mismatches and/or errors 214. These mismatches and/or errors are then communicated back to the customer site for problem resolution. A customer support engineer may also provide instructions for correcting the problem based on the mismatches and/or errors.

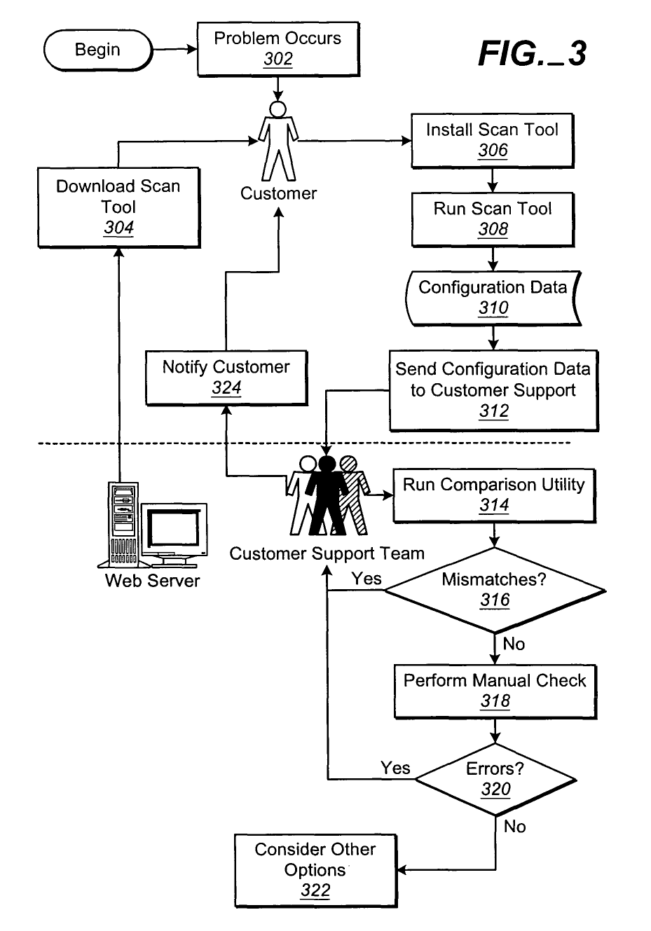

Turning to FIG. 3, a flowchart illustrating the operation of remote problem resolution is shown in accordance with a preferred embodiment of the present invention. The process begins and a problem occurs (step 302). The customer downloads a scan tool (step 304) from the company Web server or the like. Then, the customer installs the scan tool (step 306) and runs the scan tool (step 308). The scan tool generates and stores configuration data (step 310) and sends the configuration data to the customer support site (step 312).

The customer support team receives the configuration data and runs the comparison utility (step 314). A determination is made as to whether mismatches are identified by the comparison utility (step 316). If mismatches are identified, they are presented to the customer support team. If no mismatches are identified in step 316, the customer support team performs a manual check (step 318). The manual check may be performed by a field engineer, developers, a test engineer, a customer support engineer, or any combination of the above. The manual check may alternatively be performed by any other qualified personnel.

A determination is made as to whether errors are identified in the configuration data (step 320). If errors are identified, they are presented to the customer support team. For example, the mismatches may be presented on a display screen so that customer support personnel may provide assistance or instructions to the customer by telephone or electronic mail. Otherwise, if no errors are identified in step 320, other options are considered (step 322), such as an on-site debugging process. Thereafter, the customer support team notifies the customer of the mismatches, errors, or other instructions for resolving the problem (step 324). The customer support team may notify the customer of mismatches, errors, or other instructions by communicating with the customer using, for example, telephone, electronic mail, or personal communication.

Thus, the present invention solves the disadvantages of the prior art by providing a mechanism for remote customer serviceability. The mechanism of the present invention is highly flexible. Any time the scan tool is not allowed or the method cannot be applied to a particular customer situation, any existing debug process can still be applied.

The automated data collection is fast and highly efficient. The installation and execution of the scan tool should not take more than a few minutes. The collected data has more details than data typically collected by a human. Since the data collection is automated, the mechanism of the present invention may enhance data quality, since human error may be minimized.

The code level database maintains all valid configurations and combinations. The code level database is easy to manage and maintain. Current and historical data may be checked and compared and no data will be lost, overlooked, or forgotten. Automated data comparison against the code level database is fast and efficient. Every code level may be examined carefully and equally.

The mechanism of the present invention reduces cost. Customer support engineers can greatly reduce the amount of traveling. Development teams can enjoy fewer support calls and less traveling, because common errors can be identified and resolved during the data comparison with the code level database. Furthermore, the mechanism of the present invention enhances the company's product serviceability. The overall troubleshooting response time may be reduced and the quality of customer support services is increased. In fact, product serviceability is increased without exposing any confidential data or giving up any business functionality. The comparison and debug functionality remain within the company infrastructure; therefore, customers cannot access the database and the comparison utility outside of the company's firewall.

The mechanism of the present invention may also generate opportunities for additional revenue. The company may charge service expenses to customers based on actual services rendered. In the meantime, customer satisfaction is improved, because the customer is not asked a battery of configuration questions. The root cause of configuration problems may be found in minutes, rather than hours, days, or weeks. In addition, failed attempts to swap out suspected failed parts may drop as the root cause of configuration issues may be more positively identified.

It is important to note that while the present invention has been described in the context of a fully functioning network of data processing systems, those of ordinary skill in the art will appreciate that the processes of the present invention are capable of being distributed in a form of a computer readable medium of instructions and in a variety of forms. Further, the present invention applies equally regardless of the particular type of signal bearing media actually used to carry out the distribution. Examples of computer readable media include recordable-type media such a floppy disc, a hard disk drive, a RAM, a CD-ROM, a DVD-ROM, and transmission-type media such as digital and analog communications links, wired or wireless communications links using transmission forms such as, for example, radio frequency and light wave transmissions. The computer readable media may take the form coded formats that are decoded for actual use in a particular data processing system.

1. A method for remote customer serviceability, the method comprising:
responsive to a problem with a product at a customer site, running a scan tool, wherein the scan tool collects debug data for the product;
sending the debug data to a customer support site;
comparing the debug data to code level data, using a comparison utility at the customer support site, to identify mismatches.

2. The method of claim 1, further comprising:
storing the debug data at the customer site.

3. The method of claim 2, wherein the debug data is stored in binary format.

4. The method of claim 2, wherein the customer site is protected by a firewall or security check and wherein the debug data is stored in text format.

5. The method of claim 1, further comprising:
sending identified mismatch information to the customer site.

6. The method of claim 1, further comprising:
presenting identified mismatch information to customer service personnel.

7. The method of claim 1, wherein the step of comparing the debug data to code level data includes identifying preferred code levels for the product.

8. The method of claim 1, further comprising:
downloading the scan tool from a Web server.

9. The method of claim 1, further comprising:
providing the scan tool to the customer on a removable storage medium.

10. A system for remote customer serviceability, the system comprising:
a scan tool, wherein the scan tool is run responsive to a problem with a product at a customer site to collect debug data for the product;
a communication medium, wherein the scan tool sends the debug data to a customer support site using the communication medium;
a comparison utility at the customer support site, wherein the comparison utility compares the debug data to code level data to identify mismatches.

11. The system of claim 10, further comprising:
a storage unit at the customer site, wherein the storage unit stores the debug data at the customer site.

12. The system of claim 11, wherein the debug data is stored in binary format.

13. The system of claim 11, wherein the customer site is protected by a firewall or security check and wherein the debug data is stored in text format.

14. The system of claim 10, further comprising:
a presentation device at the customer service site, wherein the presentation device presents identified mismatch information to customer service personnel.

15. The system of claim 10, wherein the comparison utility identifies preferred code levels for the product.

16. The system of claim 10, further comprising:
a Web server, wherein the scan tool is downloaded from the Web server.

17. The system of claim 10, further comprising:
a removable storage medium, wherein the removable storage medium provides the scan tool to the customer.

18. An apparatus for remote customer serviceability, the apparatus comprising:
means, responsive to a problem with a product at a customer site, running a scan tool, wherein the scan tool collects debug data for the product;
means for sending the debug data to a customer support site; and
means for comparing the debug data to code level data, using a comparison utility at the customer support site, to identify mismatches.

19. The apparatus of claim 18, further comprising:
means for presenting identified mismatch information to customer service personnel.
